(19) United States
(12) Patent Application Publication
(10) Pub. No.: US 2013/0113601 A1
(43) Pub. Date: May 9, 2013

(54) Obstacle Detection for Visually Impaired Persons

(71) Applicants: Francis San Luis, San Luis Obispo, CA (US); Scott Edward Chapman, San Luis Obispo, CA (US); Michael Boyd, San Luis, CA (US); Nathan Helenihi, San Luis Obispo, CA (US); Susan A. Marano, San Luis Obispo, CA (US); Aaron N. Martinez, San Luis Obispo, CA (US); Aaron Morelli, San Luis Obispo, CA (US); Eric Osgood, San Luis Obispo, CA (US); Joseph San Diego, San Luis Obispo, CA (US); Alan Q. Truong, San Luis Obispo, CA (US)

(72) Inventors: Francis San Luis, San Luis Obispo, CA (US); Scott Edward Chapman, San Luis Obispo, CA (US); Michael Boyd, San Luis, CA (US); Nathan Helenihi, San Luis Obispo, CA (US); Susan A. Marano, San Luis Obispo, CA (US); Aaron N. Martinez, San Luis Obispo, CA (US); Aaron Morelli, San Luis Obispo, CA (US); Eric Osgood, San Luis Obispo, CA (US); Joseph San Diego, San Luis Obispo, CA (US); Alan Q. Truong, San Luis Obispo, CA (US)

(73) Assignee: The Quality of Life Plus (QL+) Program, McLean, VA (US)

(21) Appl. No.: 13/420,579

(22) Filed: Mar. 14, 2012

Related U.S. Application Data
(60) Provisional application No. 61/452,618, filed on Mar. 14, 2011.
(60) Provisional application No. 61/453,040, filed on Mar. 15, 2011.
(60) Provisional application No. 61/610,314, filed on Mar. 13, 2012.

(51) Int. Cl. G09B 21/00

(52) U.S. Cl. CPC G09B 21/001
USPC 340/4.1

(57) ABSTRACT

Systems, components, and methods are described for obstacle detection by visually impaired users. A system can include a support element, such as a mobility cane, and one or more object sensors such as sonar, lidar, RF, or radar sensors. A system can also include a control system. A user interface may be included. The user interface may be attached or connected to the control system and/or support element. The object sensors may be oriented in multiple, separate directions.

### RELATED APPLICATIONS

This application claims the benefit of U.S. Provisional Patent Application No. 61/452,618 filed 14 Mar. 2011 and entitled “Obstacle Detection for Visually Impaired Persons”; U.S. Provisional Patent Application No. 61/453,040 filed 15 Mar. 2011 and entitled “Obstacle Detection for Visually Impaired Persons’; and, U.S. Provisional Patent Application No. 61/610,314, filed 13 Mar. 2012 and entitled “Obstacle Detection for Visually Impaired”; the entire contents of all of which applications are incorporated herein by reference.

### BACKGROUND

The present disclosure is directed to cost effective technology and techniques that can aid blind persons or persons with low or impaired vision in the detection of obstacles and/or hazards.

Some existing tools for the visually impaired community have proven to be insufficient in alerting users to all hazards and obstacles which may threaten their safety, health or independence. Issues identified to date include traffic signals, construction zones, bicyclists, tree limbs, and/or obstacles which may be at or above waist height.

### SUMMARY

Devices and techniques are disclosed that can provide reliable, cost-effective, and robust obstacle detection for visually impaired persons. Components of a detection system can include the following: a support element for a visually impaired person such as a cane, e.g., made of a suitable material (e.g., fiberglass, carbon fiber, light metals, wood, plastic, etc.); one or more proximity or object/obstacle detection sensors such as sonar and/or radar transducers or capacitive proximity sensors; a control system/controller; and, communication functionality between the proximity sensor(s) and the person, e.g., a wireless communication systems (e.g., Bluetooth, RF, etc.) used with an ear device for providing audio feedback to the user. Other feedback modalities may be used, e.g., vibration sensing, etc.

### BRIEF DESCRIPTION OF THE DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a block diagram for a system for obstacle detection in accordance with the present disclosure.

FIG. 2 illustrates a block diagram of an obstacle detection system utilizing one or more sonar sensors, in accordance with the present disclosure.

FIG. 3 depicts a circuit diagram of an example of a boost converter used for an embodiment.

FIG. 4 shows a motor controller circuit for exemplary embodiments.

FIG. 5 depicts a circuit for connecting multiple sensors together with constant looping to prevent interference caused by having multiple sensors within a single system.

FIG. 6 shows a circuit diagram for an exemplary control system used for an embodiment.

FIG. 7 shows the related circuit board layout for the circuit depicted in FIG. 6.

FIG. 8 shows a printed circuit board layout for the charging circuit for the battery as used with the circuit shown in FIGS. 6-7.

FIG. 9 depicts a flowchart for a method or software process implemented in/by a controller for exemplary embodiments.

FIG. 10. shows a diagram depicting the angles at which each of two sensors were configured and held for an exemplary embodiment.

FIG. 11 shows a configuration of two sensors, consistent with FIG. 10.

FIG. 12 depicts a set of views (A-C) of an example of a housing for exemplary embodiments.

FIG. 13 depicts an embodiment of an obstacle detection system having an alternate form factor.

FIG. 14 depicts a prototype implemented for an alternate embodiment.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

It will be appreciated that other configurations of the subject technology will become readily apparent to those skilled in the art from the following detailed description, wherein various configurations of the subject technology are shown and described by way of illustration. For example, while some electrical components may be indicated with specified nominal ratings, these are for ease of illustration and are not the only manner of implementing such electrical components or related circuitry. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

The various preferred embodiments disclosed herein relate to systems, apparatus, and methodologies useful for allowing or facilitating detection of objects, such as obstacles and the like, by persons who are visually impaired.

Reference now is made in detail to the examples illustrated in the accompanying drawings and discussed below.

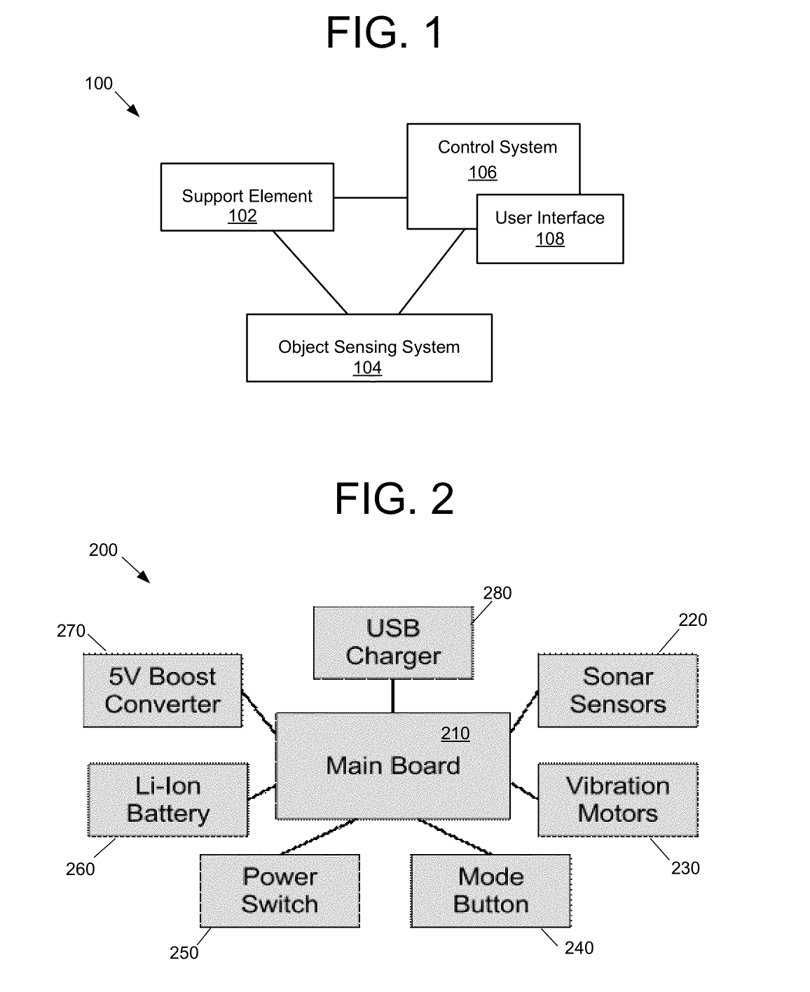

FIG. 1 depicts a block diagram indicating general features of a system 100 for obstacle detection in accordance with the present disclosure. System 100 can include a support element 102, e.g., a mobility cane. Support element 102 can be suitable to support or hold one or more devices and/or components such as a an object (obstacle) sensing system 104. The object sensing system 104 can include a number of obstacle detection transceivers/transducers, as described in further detail herein. System 100 can also include a control system 106 for control and/or operation of the object sensing system 104. A frame or housing (not shown) may be present for housing the object sensing system 104 and/or the control system 106, e.g., on or coupled to the support element. Any suitable material may be used for the housing. A user interface 108 may be included, as shown. The user interface 108 may be attached or connected to the control system 106 and/or support element 102.

In exemplary embodiments, the object sensing system 104 can include one or more obstacle detection transceivers/transducers such as ultrasonic transducers, RF transducers, radar and/or lidar transceivers, or the like.

The user interface 108 can include one or more vibration motors for providing vibration feedback to a user when the object sensing system 104 detects an object. The user interface 108 can include the handle or portion thereof of the support element 102. The user interface can include an audible battery alarm and/or signal that indicates an operation mode of the system.

As part of the user interface 108, a handle of the device (e.g., mobility cane) may orient the sensors of the object detection system 104 in desired orientations and allow feedback to be felt by a user (including feedback of vibration from or contact with the ground surface). To facilitate this, in exemplary embodiments, vibration pads may be isolated from the cane and the user may be guided to place their fingers on the power switch and vibration pads properly by the designed shape of the device.

As was stated, the user interface 108 can include vibration; for this, response time and accuracy are important factors. Too slow vibrations or too often incorrect vibrations can reduce effectiveness. The vibration(s) afforded are preferably specific and noticeable. For some embodiments, the strength of vibration can be incrementally increased as a user approaches an object and decreased when the user moves away from an object. This way, a user can start feeling the vibration early and at a low strength rather than getting a sudden strong vibration.

The user interface 108 can also include one ore more audible alarms. For example, there may be an audible alert for battery level.

As will be described in further detail below, the user interface 108 can also include the shape or form factor of a housing used for the system. For some implementations, a slip-over-cane (like a sleeve) form factor can be particularly advantageous and user-friendly, considering the cost, discretion, and importance of user comfort. The option to use any cane that they prefer without having an embarrassing attachment is superior to any other device on the market.

FIG. 2 illustrates a block diagram of an obstacle detection system 200 utilizing multiple object detection sensors in the form of sonar sensors, in accordance with the present disclosure. System 200 includes a main printed circuit board (PCB) 210, suitable for a controller or processor (not shown). One or more sonar sensors 220 are operatively coupled/connected to the main board 210 and function to object/obstacle detection. One or more vibration motors 230 are operatively coupled/connected to the main board 210 and function to provide feedback to a user, such as when an obstacle is detected. A mode button 240 (or other functionally equivalent switch) can be present. Power switch 250 is shown, as well. Other power components such as a Li-ion battery 260, 5V boost converter 270, and a USB charger 280 may also be present. Other types of batteries other than Li-ion or Li-polymer ion may of course be used. Some or all of the described parts of system 200 can be configured in a housing, e.g., as attached to a cane, for use by a visually impaired person.

In an exemplary implemented embodiment of system 200, sonar sensors commercially available by the make and model EZ High Performance Sonar Range Finder were used. A main board 210 including an Arduino Mini Pro with a microcontroller made commercially available by Atmel Corporation with model number ATMEGA328P-AU was used, and was configured to takes inputs from the Li-ion battery (cell) 260, control buttons 240, 250 and the MaxSonar Sensors 220 while outputting to the vibration motors 230 and a speaker (not shown). Such a microcontroller may offer certain benefits. For example, for some applications, such a microcontroller may be configured to provide battery meter functionality. For example, such a battery meter can utilize the ADC on the ATMEGA microcontroller to determine the voltage of the Lithium-polymer/Ion battery cell. Since the battery cell voltage (3.7V) can be designed to be less than the operating voltage of the microcontroller (5.0V), no additional circuit is needed. The battery meter can be configured to only check that battery charge every specified number of sonar readings, e.g., set to roughly 10 minute intervals.

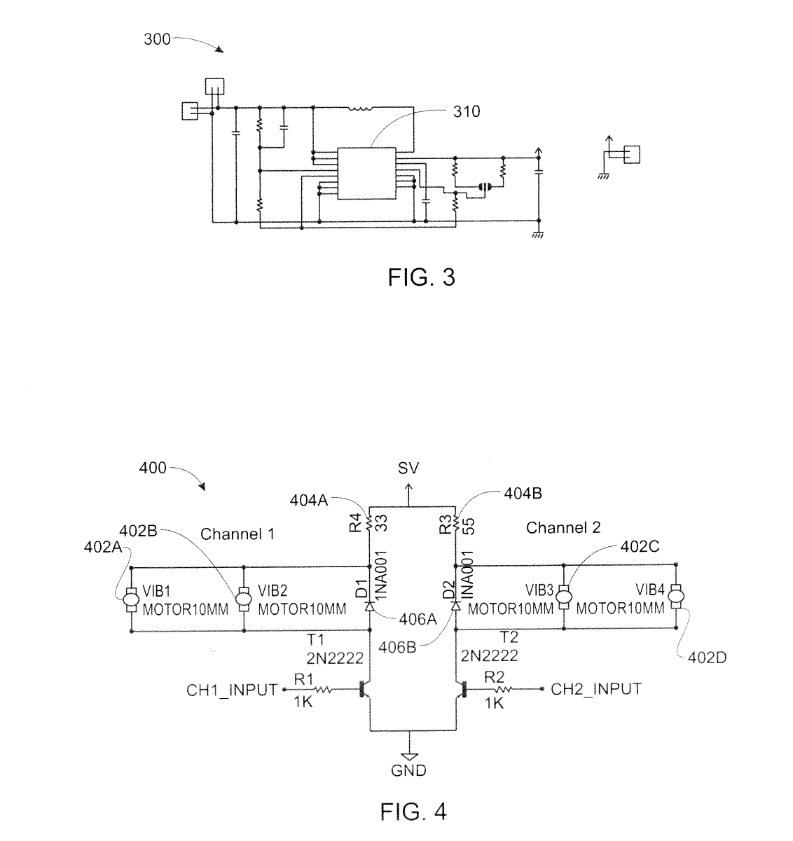

FIG. 3 depicts a circuit diagram of an example of a boost converter circuit 300 used for exemplary embodiments. Controller 310 is shown. The boost converter 300 may be used to generate a regulated desired voltage (e.g., 5.0V) from an input voltage of between, e.g., 0.3V-5.5V by using controller 310 implemented in a boost configuration. For an exemplary embodiment, the a Texas Instrument TPS6100 IC was utilized for controller 310; it is capable of providing 600 mA at 5V, and contains an under-voltage lock out set at 2.6V to prevent over-draining, e.g., of Lithium-polymer/Ion batteries.

FIG. 4 shows a motor controller circuit 400 useful for exemplary embodiments of the present disclosure. Circuit 400 may be used to drive vibration motors, e.g., 402A-402D, as shown. In some applications, the various vibration motors can be allocated among different channels (e.g., two channels). The circuit 400 may be used to supply or ensure sufficient current for an obstacle detection system, e.g., system 200 of FIG. 2; thus, the delivered current can exceed that which a microcontroller could deliver through its I/O pins. As shown, resistors 404A-404B may be used to drop the a supply voltage (e.g., 5V) down to an operating voltage of the vibration motors 402A-402B (e.g., 2.6V-3.8V).

As is further shown in FIG. 4, flyback diodes 406a-4046 may be used in exemplary embodiments of circuit 400 to eliminate or facilitate elimination of sudden voltage spikes from inductive loading (e.g., as caused by motors 402A-402D) when a supply voltage is suddenly reduced or removed.

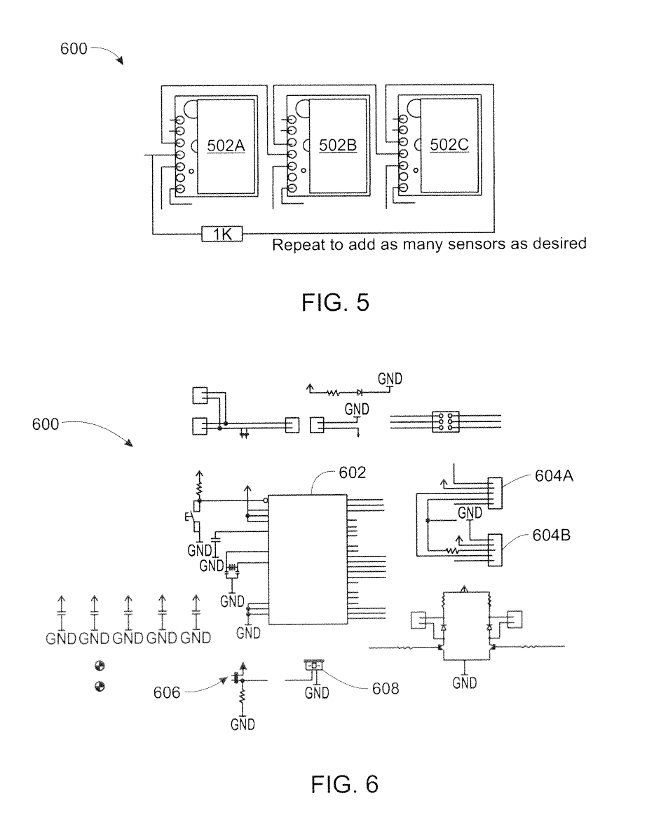

FIG. 5 depicts a circuit 500 for connecting (e.g., daisy-chaining) multiple sensors (e.g., sonar) together with constant looping to prevent interference caused by having multiple sensors within a single system. Circuit 500 represents a hardware solution to allow sensors (such as sonar sensors) to handle timing between multiple sensors by sequentially firing off each sensor. Transmit pins are indicated by TX and Receive pins are indicated by RX. Ground and 5V pins are also shown. As shown in FIG. 5, sonar sensors (indicated by PCBs 502A-502B, one for each sensor) can be connected via daisy chaining by connecting the TX pin of the first sensor to the RX pin of the next sensor. On the last sensor, the TX pin is tied to the RX pin of the first sensor with a, e.g., 1K ohm, resistor to allow it to constantly loop and update the sensors' readings.

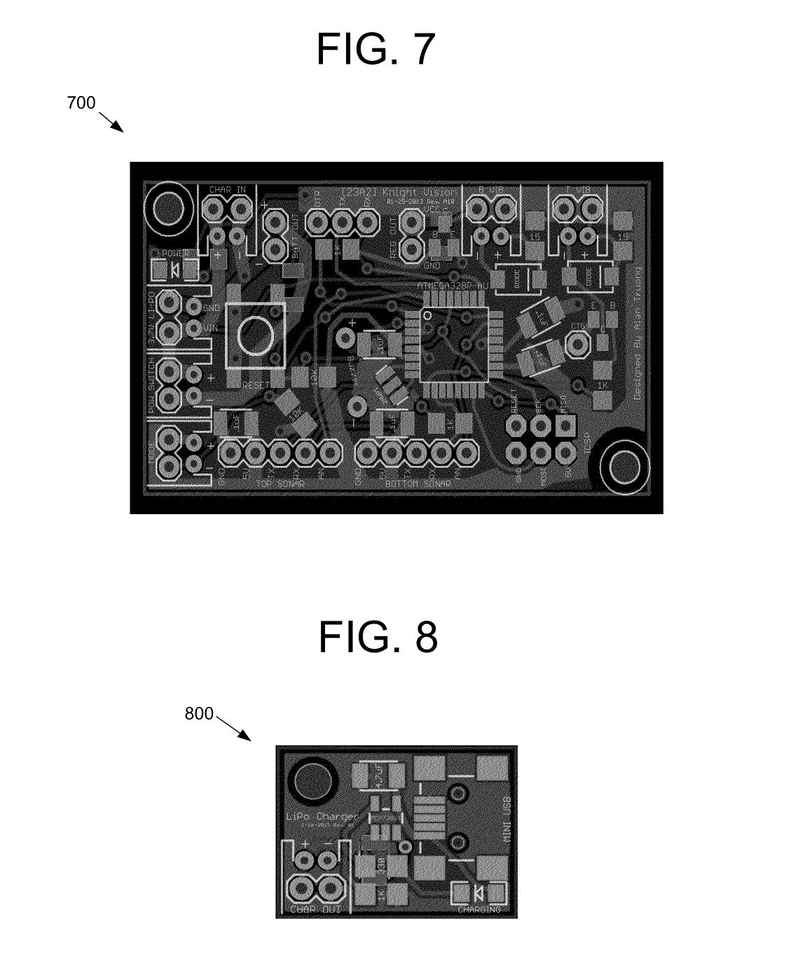

FIG. 6 shows a circuit diagram of an example of a control system circuit 600 used for an exemplary embodiment. As indicated, circuit 600 may include controller 602 and sonar sensors/transceivers 604A-604B. Mode button 606 (e.g., as part of a user interface) and buzzer 608 may also be present. The implemented embodiment depicted in FIG. 6 was the main control board for the system. FIG. 7 shows the related circuit board layout of the PCB 700 used for the circuit depicted in FIG. 6.

FIG. 8 shows a printed circuit board layout 800 for a charging circuit for the battery used with the circuit shown in FIGS. 6-7.

Exemplary embodiments of the disclosed technology may utilize methods and/or software processes suitable for implementing various filters for use with the data received from the object/obstacle detection system or sensors. For example, a median filter may be used in order to ensure accurate data from sonar or other sensors such as lidar or radar sensors. Such filtering may be used to ignore or discard outlier data, e.g., such as caused by the environment or noise on the power line, etc. A suitable algorithm/method can use an array of the, e.g., five, latest sonar readings, for example. From these sonar readings, the filter can sort the array and output the median value. Unlike averaging, a median filter output value is not greatly affected by any single outlier since those values would be sorted to the edge of the array. Of course other suitable filters may be implemented in substitution for or addition to a median filter for methods/systems according to the present disclosure.

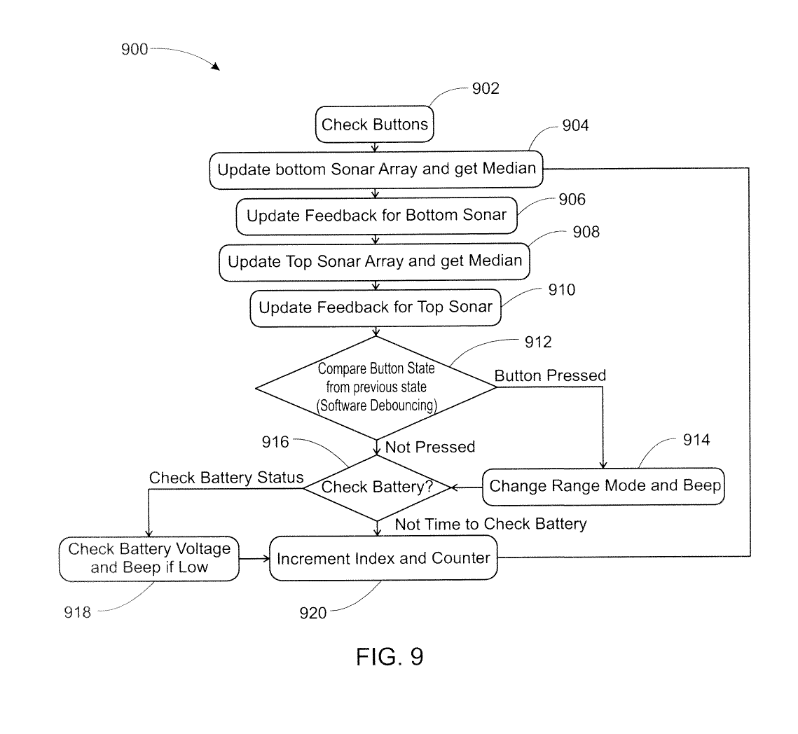

FIG. 9 depicts a flowchart for a method 900 (e.g., implemented as a software process implemented in/by a controller) for exemplary embodiments.

The method 900 may begin by checking the mode button state (e.g., of mode button 240 of FIG. 2), as described at 902. Next, the sonar value for the bottom sensor can be read, calculating the median data value for that sensor, as described at 904. An updating step then occurs for the vibration feedback based the median value, as described at 906. The process is repeated for each sensor (e.g., two sonar sensors, three sensors, etc., as described at 908-910.

Continuing with the description of method 900, the mode button state is read in (determined) once again and compared with the original state, utilizing the inherent delay between these readings to remove button de-bouncing errors, as described at 912. If the button is determined to have been pressed, the range settings will be changed, as described at 914. The method 900 continues by checking if it should check the battery voltage by comparing a count value, as described at 916. The battery voltage can be checked and if low, a signal such as an auditory or other alarm (“beep”) can be generated, as described at 918. Lastly, the method 900 increments the sonar array index, and/or the battery meter counter, as described at 920.

For the mechanical design of exemplary embodiments, e.g., as used with standard mobility canes, typical distances and geometric details of use for nominally “average” users can be considered.

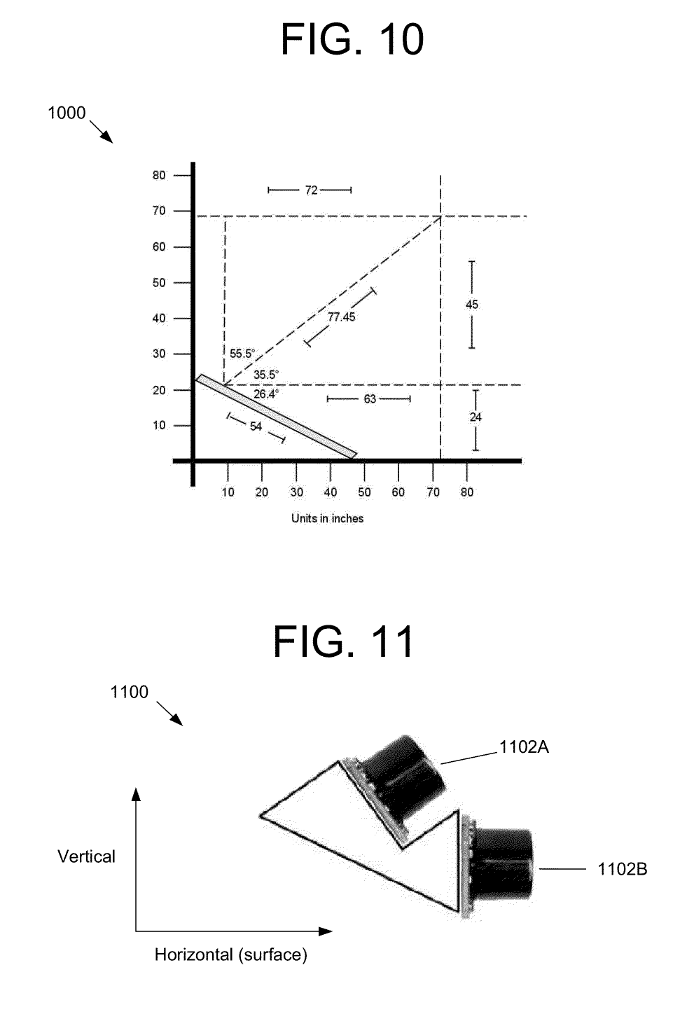

For example, FIG. 10 depicts a diagram 1000 with details for sonar sensor placement for a user with median (average) physical characteristics and operating conditions. Units are given in inches; the conversion to centimeters is 1.0 inches=2.54 centimeters (25.4 millimeters).

As shown in FIG. 10, optimal angles at which each of two sensors can be configured, respectively, for use with a cane and to provide object detection (e.g., by use of a projected sound beam/lobe) in both horizontal and vertical directions. From the figure, it may be noted that although the user height may vary, a significant factor in having optimal sensor angles are based on a user's actual body proportions (e.g., leg length, arm Length, etc.). As long as the users are of average proportion, and use a proper (standard) mobility cane length, optimal angles may be maintained without need for adjustments.

As shown in FIG. 10, the design and calculations for the placement of the sonar sensors, for an exemplary embodiment of the subject technology, were calculated, assuming that the average height of a user is 5 ft. 9 in, with the mobility cane being held at about 24 inches from the ground. The angles are based on the desired radius of at least 6 feet from the user. The purpose of the two sensors is so that they can detect both low hanging objects and higher objects that the mobility cane alone would miss. The bottom sensor can be facing straight ahead, when the mobility cane is held at about 2 feet from the floor, while the top sensor can be placed at an angle of 35.5 degrees so that it could detect higher obstacles. Of course, while certain angles of mounting may be preferable for two sensors, other angles may be used. Further, more or less than two sensors may be used with a mobility cane for various applications.

FIG. 11 shows a configuration (layout) 1100 of two sensors 1102A-1102B, consistent with FIG. 10. The orientations of the sensors 1102A-1102B are shown relative to a horizontal surface and vertical (normal) direction to that surface, e.g., could be encountered by a user holding a mobility cane implementing an object detection system according to the subject disclosure.

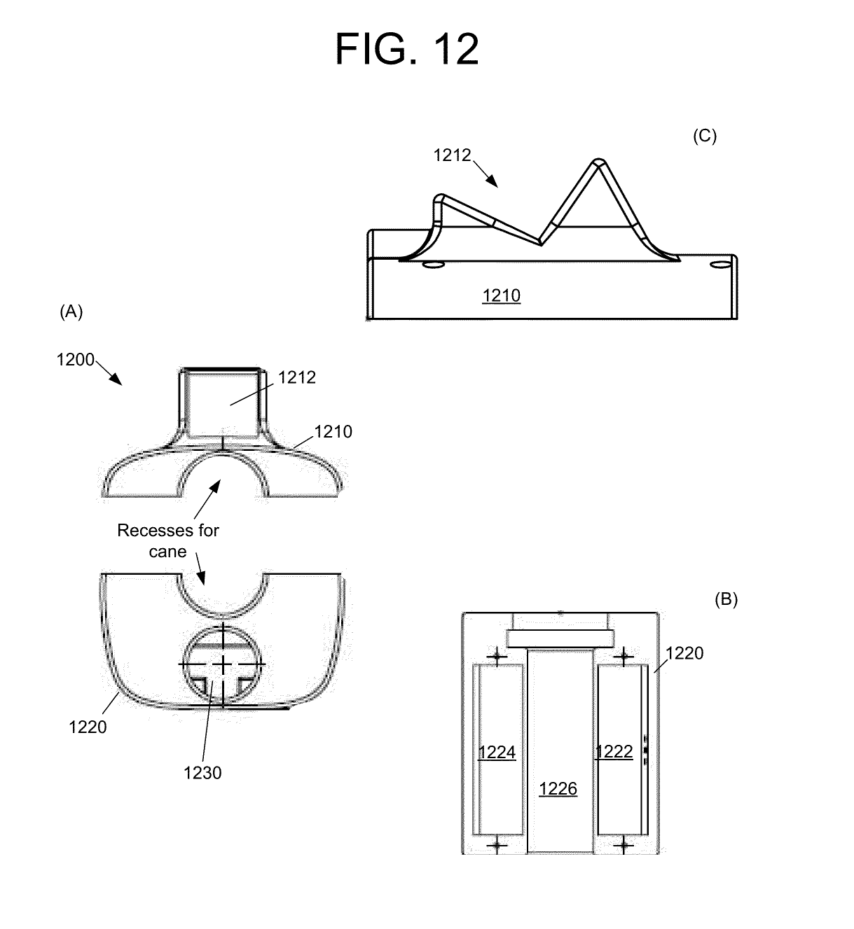

FIG. 12 depicts a set of views (A-C) of an example of an enclosure or housing 1200 for exemplary embodiments. The housing 1200 can be designed to house the electronic components for an object detection system according to the present disclosure. For exemplary embodiments, the housing 1200 can include three components that can be pieced together to form a complete unit.

View (A) of FIG. 12 depicts a front exploded view of a top component 1210 and bottom component 1220 of the housing 1200. Recesses (shown by arrows) in the upper 1210 and bottom 1220 components, respectively, may be configured or adapted to received a mobility cane. Thus, for exemplary embodiments, a user's mobility cane may be surrounded by the top 1210 and bottom 1220 components. As further shown in view (A), a second hole 1230 at the bottom of the housing 1200 may be present where the battery will be housed.

View (B) of FIG. 12 shows the top view of the bottom component 1220. This bottom component 1220 can be used to house a PCB 1222 (e.g., PCB 700 of FIG. 7), battery 1224, and a charging unit 1226; these components can have paths (not shown) that will be used to lay the wiring to connect the electronic components together, as well as connecting the battery.

View (C) of FIG. 12 shows a side view of the top component 1210 of the device. As show, a multifaceted surface 1212 can be present to hold sensors in desired orientations, e.g., as shown in FIGS. 10-11.

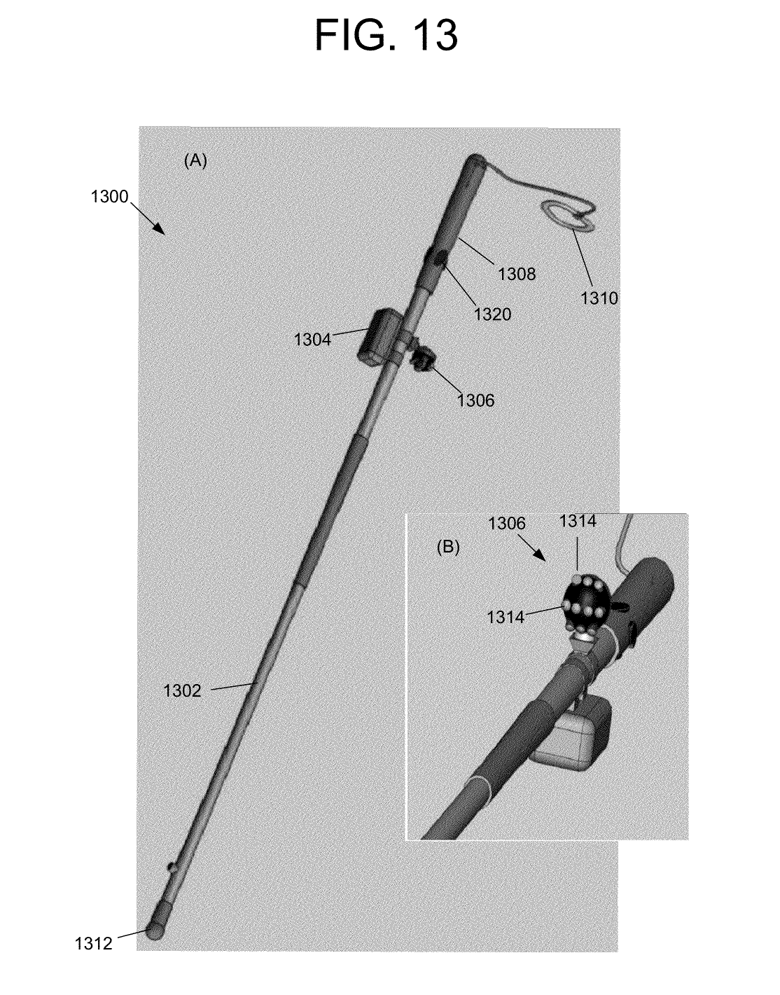

FIG. 13 depicts views (A) and (B) of an embodiment of an obstacle detection system 1300 having an alternate form factor. A mobility cane 1302 is shown with a housing 1304 for electronic components (e.g., components 210-280 of FIG. 2). A user input mechanism 1306 is shown, including a number of buttons 1314. A handle 1308 is shown with a number of vibrating buttons or vibration pads 1320, for user feedback. A tether 1310 and tip 1312 are shown. Tether 1310 may include vibratory functionality for user feedback in some applications.

### Exemplary Embodiment: Prototype Design

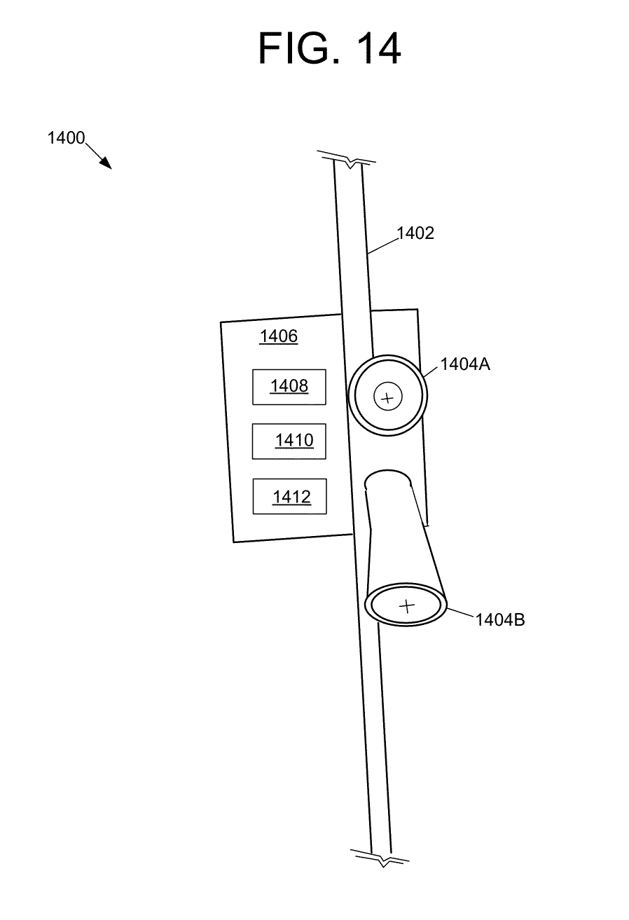

FIG. 14 depicts a prototype 1400 of an object detection system implemented for an alternate embodiment. The prototype 1400 included a mobility cane (indicated by shaft 1402), two sonar transceiver 1404A-1404B, and a housing 1406. The housing 1406 included a controller board 1408 with a microcontroller (Arduino UNO board with ATmega8U2 microcontroller made commercially available by Atmel Corporation). A power supply 1410 and a user interface 1412 were also included.

Accordingly, embodiments of the disclosed technology can afford various advantages relative to previous techniques/technology, include any one or more of the following: relatively low cost; long battery life (e.g., 8+ hour battery life); compatibility with Lithium-polymer/Ion batteries; user interface features (e.g., a button) to indicate (e.g., audibly) output battery level; advantageous form factor (e.g., lighter and smaller such as less than 2 pounds); non-uniform grip; easy access on/off switch; vibration intensity adjustment; precise output (e.g., one inch resolution); and, the ability to detect obstacles commonly missed by a mobility cane (e.g., an overhanging tree branch, or fence structure, etc.).

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

In reading the present disclosure, one skilled in the art will appreciate that embodiments of the present disclosure can be implemented in hardware, software, firmware, or any combinations of such, and over one or more networks. Suitable software can include computer-readable or machine-readable instructions for performing methods and techniques (and portions thereof) described herein, and/or of designing and/or controlling the implementation of various components described herein, or of data acquisition and/or data manipulation and/or data transfer according to the present disclosure. Any suitable software language (machine-dependent or machine-independent) may be utilized. Moreover, embodiments of the present disclosure can be included in or carried by various signals, e.g., as transmitted over a wireless RF or IR communications link and/or sent over the Internet.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications which have been cited in this disclosure are hereby incorporated herein by reference.

What is claimed is:

1. A system for obstacle detection, the system comprising:
a support element;
an obstacle sensing system attached to the support element; and
a control system configured connected to the support element and configured to control the obstacle detection system and provide feedback to a user.

2. The system of claim 1, wherein the control system includes a user interface configured to receive input commands from a user and to provide feedback to the user about the operation of the obstacle sensing system.

3. The system of claim 1, wherein the obstacle sensing system includes a sonar transceiver.

4. The system of claim 1, wherein the obstacle sensing system includes a radar transceiver.

5. The system of claim 1, wherein the obstacle sensing system includes a lidar transceiver.

6. The system of claim 1, wherein the obstacle sensing system includes an infrared transceiver.

7. The system of claim 1, wherein the obstacle sensing system includes a RF transceiver.

8. The system of claim 1, wherein the user interface includes a vibration motor.

9. The system of claim 1, wherein the user interface includes one or more buttons configure to receive mechanical input from the user.

10. The system of claim 1, wherein the user interface includes a speaker for indicating a status of the system.

11. The system of claim 10, wherein the status indicates proximity to an object.

12. The system of claim 10, wherein the status indicates an operational condition of a battery used by the control system.

13. The system of claim 1, further comprising a housing configured to hold the control system.

14. The system of claim 13, wherein the housing is configured to receive the obstacle sensing system.

15. The system of claim 14, wherein the housing is configured to receive the obstacle sensing system so that a first obstacle detection sensor is configured in a first orientation with respect to the support element and so that a second obstacle detection sensor is configured in a second orientation with respect to the support element.

16. The system of claim 1, wherein the support element comprises a cane.

17. The system of claim 1, wherein the control system comprises a median filter configured to calculate a median value of data signals received from the obstacle sensing system.

18. A control system adapted to control an obstacle detection system; the system comprising:
a controller configured to receive inputs signals from a object sensing system, and to provide output signals to a user interface about the operation of the obstacle sensing system.

19. The control system of claim 18, wherein the user interface is further configured to receive command signals from a user and supply them to the controller.

20. The control system of claim 18, wherein the object sensing system comprises one or more sonar transceivers.
